(19) United States
(12) Patent Application Publication
(10) Pub. No.: US 2009/0071992 A1
(43) Pub. Date: Mar. 19, 2009

(54) Adjustable accessory mount

(76) Inventor: Patrick Joseph Franz, Portland, OR (US)

Correspondence Address: Patrick J. Franz, 3450 SE Alder, Portland, OR, 97214, US

(21) Appl. No.: 11/901,805

(22) Filed: Sep. 18, 2007

(51) Int. Cl. B62J 7/06

(52) U.S. Cl. 224/420

(57) ABSTRACT

In accordance with one embodiment, an adjustable accessory mount mechanism uses two arms, a mount, and two attachment connections to the support structure. The arms are pivotably connected at the mount itself and at their attachments to the support structure. This arrangement produces an adjustable triangulated mechanism with the mount at one vertex and the existing support structure as one side of the triangle. The mount can be perpendicular or parallel to the support structure. The arms may be curved or otherwise shaped to avoid other objects. The accessory mount both spreads the load on the support structure and provides an inherently strong triangulated structure for mounting the object or accessory.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of the Invention

This invention generally relates to facilitating the attachment of useful things to various objects, specifically to the mounting of accessories such as lights and cycle-computers to bicycles.

2. Prior Art

Accessories can add enjoyment and important capabilities to bicycles, tricycles, motorcycles, and all terrain vehicles. Accessories such as lights, cycle-computers, global positioning system receivers, radios, article holders, and the like are often very desirable additions. Most accessories for such vehicles are designed to mount onto the vehicles using a clamp or a tab. If a clamp, the clamp is usually designed to attach to a cylindrical support structure on the vehicle. This is due to the fact that round tubular structures have often been common on such vehicles. The other common mounting method for accessories is a simple tab with a hole in it. This allows the accessory to be mounted to another hole on the vehicle, often using a simple bolt or other fastener.

As the variety in types and methods of construction of such vehicles has expanded, it has become more difficult to attach accessories. For example, recumbent bicycles and tricycles often do not have places things like lights and cycle-computers may easily be mounted. The sizes, locations, and angles of any available support structure may not be suitable for existing mounts. Single purpose, fixed accessory mounts made for upright diamond frame bicycles are often unusable. Similarly, bicycles made of carbon fiber and other new materials often have unusual sizes and shapes, and they may not have standard sized round tubes where needed. An accessory mount that can only attach to particular sizes of round tubes has limited application.

Further, an accessory mount that cannot be adjusted has limited usefulness. It is often desirable to position the accessory at a specific position relative to an available support structure on the bicycle. An example would be positioning a light on the front of a bicycle so that it is not obscured by cables. If the accessory mount is fixed, or not sufficiently adjustable, it may impossible to position the accessory in the desired location. This is especially true for bikes and trikes outside the traditional mainstream designs.

What is needed is a more versatile accessory mount, one that can be attached to many support structures and is adjustable over a wide range. Further, for applications on human powered vehicles, such an accessory mount should be inherently strong and light.

### Prior Art Category 1

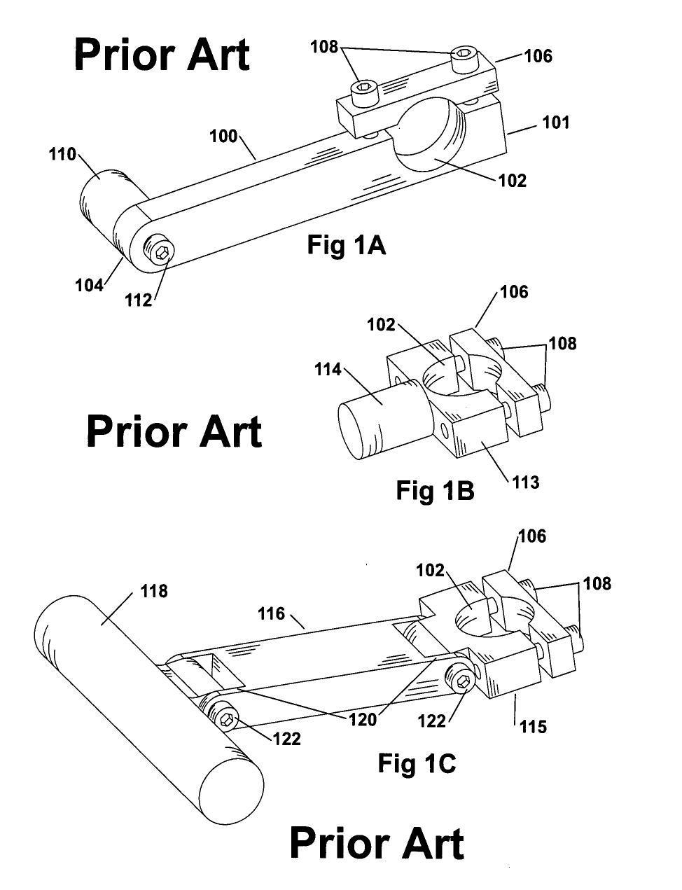

A first type of prior art accessory mount has an arm with two ends. One end of the arm is attached to the support structure, and there is a mount for the accessory on the other end of the arm. FIG. 1A shows a generic accessory mount of this type.

An arm 100 is shown with an attachment end 101 and an accessory mounting end 104. A clamp consisting of groove 102, clamp bar 106, and fasteners 108 allows the arm to be attached to a cylindrical support structure (not shown). Such support structure may be a part of a bicycle, tricycle, or other object. The clamp shown is only a sample of the many attachment methods that may be employed. Other types of clamps, as well as simple fasteners, may be employed.

At the other end of arm 100, a mount 110 and fastener 112 are provided for mounting the accessory. Again, the mount and fastener shown are merely representative, and are only two of the most common ways of doing it. For example, mount 110 may be integrally formed on arm 100 and fastener 112 is not required. Alternatively, mount 110 is not needed, and the accessory is mounted directly on fastener 112.

The arm 100 may come in many sizes and shapes. For instance, it may be long, short, L shaped, etc. The important aspect of the accessory mounts of this type is that there is some way of attaching the arm that is at a fixed distance from place the accessory is mounted. More than one arm 100 may be used in parallel to support mount 110, but if the arms are the same, they share the same limitations on attaching and positioning.

Examples of accessory mounts in this category include U.S. Pat. No. 1,069,160 to Meltz (1913), U.S. Pat. No. 1,660,131 to Lenfers (1928), and U.S. Pat. No. 6,293,449 to McGuire et al (2001). In the accessory mount of Meltz, a clamp attaches to a handlebar. An L shaped arm is attached to the clamp, and the accessory is attached to the other end of the arm. In the accessory mount of Lenfers, a pair of identical arms has clamps at each end. One of the ends of the arms clamp to a handlebar, while the other ends of the arms clamp to a cylindrical mount. In this way, the mount is parallel to and offset from the handlebar. In the accessory mount of McGuire et al, a band clamp attaches one end of an arm to a handlebar. The other end of the arm has a threaded post for the attachment of a camera.

The accessory mounts in this category have limited applicability because of their fixed nature. There are many instances where it is desired to position the accessory at some location other than that provided by the particular length of the accessory mount arm. If the support structure is cylindrical, the accessory mounts in this category may be rotated around it, but this angular positioning is often insufficient. What is needed is an accessory mount that provides a wider range of mount locations relative to the support structure.

Further, if the attachment clamp is integral to the arm 100, the available support structure must be of a compatible size and shape. Otherwise, it may not be possible to attach the arm 100 to the particular support structure. When bicycles and other vehicles were made of round tubes in standard sizes, integral clamps were a useful simplification. As the sizes and shapes of support structures have proliferated, integral clamps and attachments often render an accessory mount unusable. What is needed are several kinds of attachment clamps that may be provided separately from the arm, in order to provide more ways of attaching an accessory mount to a variety of support structures.

### Prior Art Category 2

Another class of accessory mounts is distinguished by having the mount for the accessory immediately connected to the attachment mechanism. Typically, they consist of a clamp with a mount on one side. FIG. 1B shows a generic example. A clamp 113 consisting of groove 102, clamp bar 106, and fasteners 108 allows the mount 114 to be attached to a cylindrical support structure (not shown). The clamp shown is only a sample of the many attachment methods that may be employed. A common alternative attachment clamp for this type of accessory mount is a band clamp.

Similarly, accessory mount 114 is a generic representation, and other mounts may be substituted, such as a threaded fastener. U.S. Pat. No. 4,998,652 to Champagne (1991) shows a circular clamshell type of clamp with perpendicular threaded holes for mounting an accessory, in this case a water bottle holder. U.S. Pat. No. 6,926,242 to Hall (2005) shows another clamshell type clamp with a perpendicular externally threaded mount.

The accessory mounts in this category are very simple, but are useful only in certain situations. The accessory may only be mounted perpendicular and close to one side of the support structure. It is often desirable to mount an accessory in line with the support structure, and not off to one side. What is needed is an accessory mount that can provide a perpendicular mount at a variety of positions relative to the support structure, from in line to off to one side.

### Prior Art Category 3

The accessory mounts in this category include basic adjustability. A generic example is shown in FIG. 1C. An attachment clamp 115 with groove 102, clamp bar 106, and fasteners 108 attaches to the support structure. An arm 116 with hinges 120 at each end connects attachment clamp 115 to a mount 118. Angles of hinges 120 are controlled by fasteners 122. In most cases, hinges 120 are simple friction hinges, but other forms may be used, including locking hinges with serrated teeth. The important distinction in this category is that there is pivoting adjustability at either or both of the attachment clamp end and the mount end of the arm.

An example of an accessory mount in this category is the “Swing Grip SG-200” by Minoura Co., Ltd of Gifu, Japan. This accessory mount has a band clamp type attachment clamp, an arm hinged at the attachment clamp end, and a cylindrical mount at the other end of the arm. The arm attaches to the cylindrical mount at the middle of the longitudinal side of the mount, making a T shaped arrangement. The mount may be pivotally adjusted about the hinge at the attachment clamp. The position of the mount may be adjusted, but only along an arc with its center at the axis of the hinge and the radius the length of the arm. What is needed is an accessory mount that provides a wider range of positional adjustment.

Since the arm attaches at the middle of the middle of the mount, and the arm is attached in line with the central axis of the attachment clamp, it is not possible to mount an accessory in line with the central axis of the support structure. Any accessory on such an accessory mount will be off to one side. This is undesirable if you would like the accessory mounted in line with the support structure. On bicycles, in many instances, it is most desirable to mount the accessory in line with a derailleur post, stem, or other support structure. If the accessory is mounted off to one side, it may interfere with other objects or with parts of the operator's body. What is needed is an accessory mount that allows the accessory to be mounted in line with the support structure and not necessarily off to one side.

Since mount 118 is basically attached by a lever to the attachment clamp, the hinge at the attachment clamp must be made very strong to withstand the rotational forces at the hinge. If the accessory is heavy, or the arm 116 is long, the accessory mount may droop and go out of adjustment. This is especially true if the vehicle is used in bumpy conditions. Strengthening the hinge against such forces is costly and difficult. Also, since the accessory mount uses a single attachment clamp, the forces applied to the support structure can be high.

What is needed is an accessory mount that is adjustable, yet inherently strong in supporting loads in bumpy conditions. It is further desirable to reduce the load forces at the attachment clamp so as to reduce the possibility of damage to the support structure.

### Prior Art Category 4

The accessory mounts in this category are similar to those in Category 3, but provide ball and socket joints for increased adjustability. Examples include those in U.S. Pat. No. 5,845,885 to Carnevali (1998). The accessory mount of Carnevali shows a base with a ball. An arm connects to this ball at one end and to another similar ball at the other end. The second ball is connected to a mount to which an accessory is attached. The arm may be adjusted and clamped in a variety of positions.

While the accessory mounts in this category offer good adjustability, the strength needed to hold an accessory in place tends to make the accessory mount heavy. The friction required by ball and socket joints requires additional strength and additional weight. In many situations, the extreme adjustability of the ball and socket joint is not required, and a lighter, simpler way of adjusting would be preferred.

Additionally, due to the leverage of the arm, the loads introduced by the attachment clamp on the support structure may be very high. What is needed is an adjustable accessory mount that reduces the loads imparted on the support structure.

### Prior Art Category 5

The accessory mounts in this category have multiple pivots. For example, U.S. Pat. No. 5,487,497 to Kwiatkowski (1996) shows an accessory mount with multiple slotted plates that may be pivoted as well as slidably adjusted. A central support bar has slots at each end. A pair of slotted suspension bars are bolted to the ends of the support bar via the slots, creating a pivoting double slotted connection at each end. A pair of attachment clamps are each bolted to the other ends of the slotted suspension bars, creating another pair of pivoting slotted connections. The attachment clamps are affixed to a bicycle handlebar.

This arrangement creates an adjustable accessory mount, but the multiple pivots create a trapezoidal structure that is dependent on the friction in the pivotable sliding connections to maintain its shape. What is needed is an accessory mount that has an inherently stable shape.

This accessory mount is also essentially planar. There is no depth or triangulation in the direction the pivot axes. To make this accessory mount rigid in the direction of the pivot axes, the suspension arms and central support bar would have to be made very stiff. This would be difficult to do without adding weight and expense.

### SUMMARY

In accordance with one embodiment, an adjustable accessory mount uses two arms with separate attachment clamps. The arms are pivotably connected at the mount element itself. This arrangement produces an adjustable triangulated structure with the existing support structure as one side of the triangle. The accessory mount both spreads the load on the support structure and provides an inherently strong triangulated structure for mounting the accessory.

### DRAWINGS

### Figures

FIG. 1A shows a prior art accessory mount having a fixed arm.

FIG. 1B shows a prior art accessory mount having a directly attached mount.

FIG. 1C shows a prior art accessory mount with a movable arm.

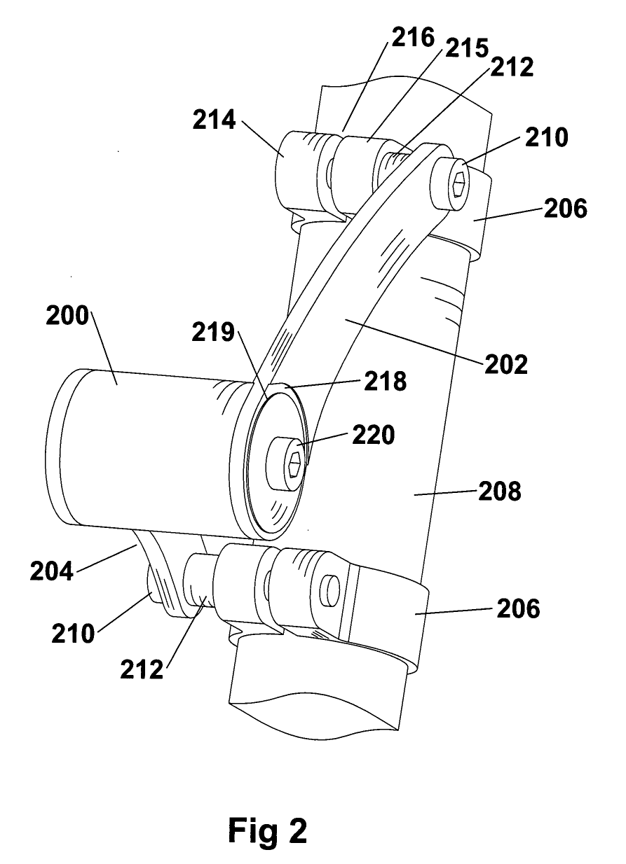

FIG. 2 is a perspective view of a first embodiment of the present invention.

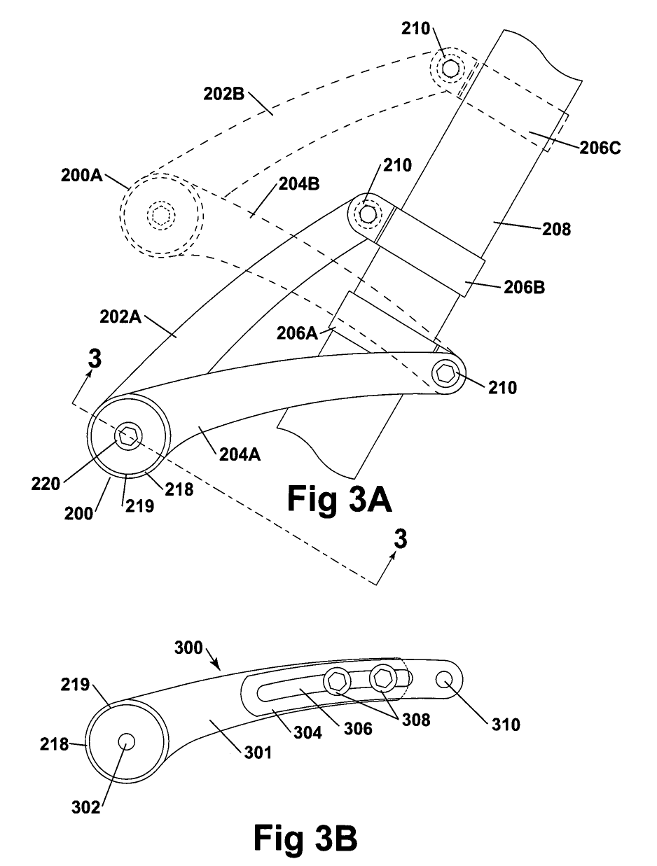

FIG. 3A is a side view of one embodiment, with an example of the adjustability.

FIG. 3B is a side view of a telescoping arm.

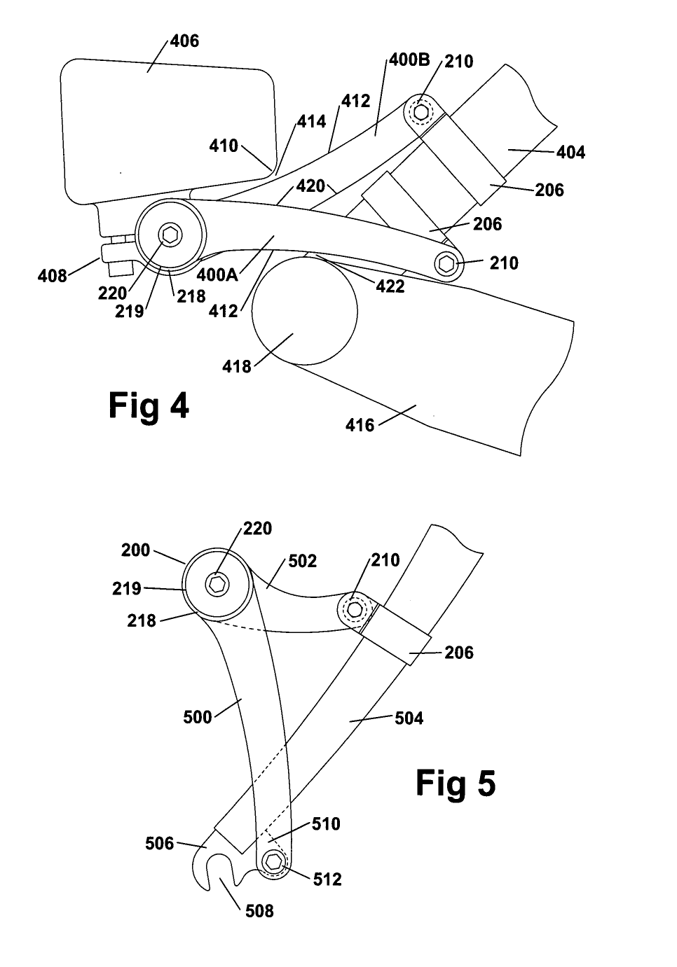

FIG. 4 is a side view demonstrating how the accessory mount clears other objects.

FIG. 5 is a side view showing an alternative attachment.

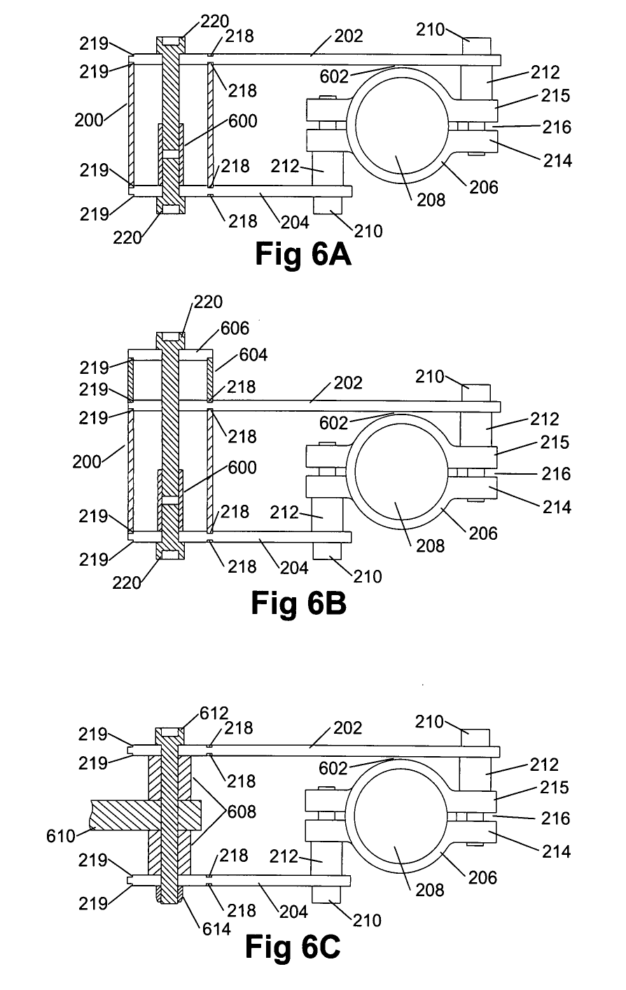

FIG. 6A is a cross sectional view of FIG. 3A, taken on section line 3-3.

FIG. 6B is a cross sectional view of an alternative embodiment showing mount extensions.

FIG. 6C is a cross sectional view of an alternative embodiment showing a different type of mount.

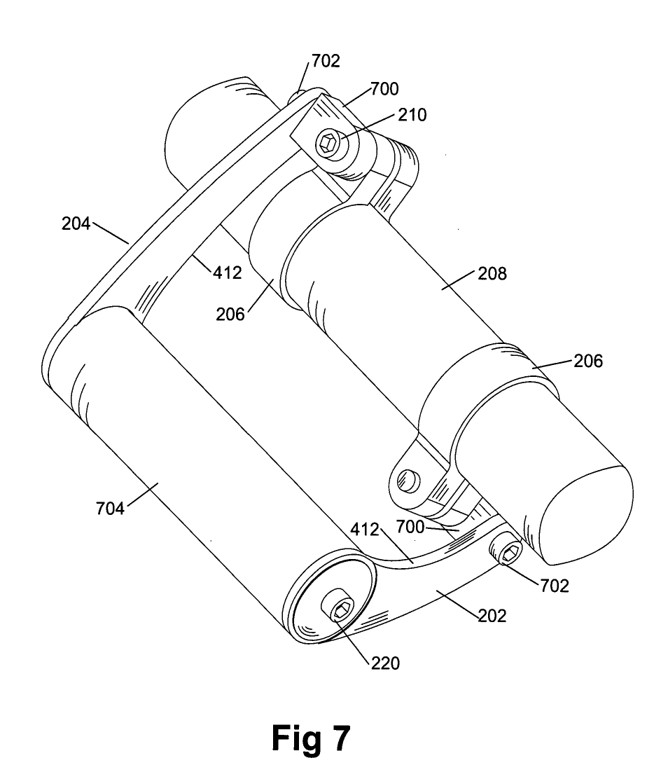

FIG. 7 shows an alternative embodiment with the mount parallel to the support structure.

### DRAWINGS

### Reference Numerals

100 Arm
101 Clamp End
102 Clamp Opening
104 Mount End
106 Clamp Bar
108 Clamp Bolts
110 Mount
112 Mounting Bolt
113 Clamp
114 Directly Attached Mount
115 Clamp
116 Pivotably Attached Arm
118 Mount
120 Friction Hinge
122 Fasteners
200 Mount
202 Upper Arm
204 Lower Arm
206 Attachment Clamp
208 Support Structure
210 Clamp Fastener
212 Spacer
214 Threaded Ear
215 Ear
216 Gap
218 Groove
219 Locating Ring
220 Mount Fastener
300 Telescoping Arm Assembly
301 Mount Arm
302 Hole
304 Slotted Arm
306 Slot
308 Control Fasteners
310 Attachment/Pivot Hole
400A Curved arm
400B Curved arm
404 Support Structure
406 Accessory
408 Accessory Mounting Clamp
410 Interfering Feature
412 Concave Side
414 Clearance
416 Frame Member
418 Bottom Bracket Shell
420 Convex Side
422 Clearance
500 Lower Arm
502 Upper Arm
504 Fork Blade
506 Dropout Plate
508 Axle Slot
510 Mounting Tab
512 Fastener
600 Coupler Nut
602 Clearance
604 Extension Mount
606 Cap
608 Spacer
610 Mounting Tab
700 Block
702 Arm Attachment Fastener
704 Mount

### DETAILED DESCRIPTION

### First Embodiment

### FIG. 2

One embodiment of an adjustable mechanism for the mounting of an object to support structure, or accessory mount, is illustrated in FIG. 2. Attachment clamps 206 grip support structure 208. Fasteners 210 and spacers 212 pivotably connect first ends of arms 202 and 204 to the attachment clamps 206. Second ends of arms 202 and 204 are pivotably connected to opposite ends of cylindrical mount 200 and held by mount fastener 220. In this way, a triangular structure is formed extending from the support structure, with the first corner of the triangle being the longitudinal axis of mount fastener 220, and the second and third corners being the longitudinal axes of clamp fasteners 210. Arms 202 and 204 are essentially link arms in two sides of a triangular adjustable linked mechanism, with the support structure being the third side of the triangle. Pivotable joints between the elements allows the triangle to be adjusted when either of the attachment clamps is moved. The pivot points are at the centers of the fastener holes in arms 202 and 204.

In this embodiment, attachment clamps 206 shown are of the flexible band type clamp. The C shaped clamp wraps around the support structure, with protruding ears 214 and 215 at each end. The ears are separated by a gap 216. Clamp fastener 210 serves to pull the ears together and cause the clamp to grip the support structure. In this embodiment, the clamp shown is of the common type where fastener 210 is a threaded bolt, ear 215 has a hole for passage of fastener 210, and threaded ear 214 threadably receives the other end of fastener 210.

In this embodiment, mount 200 is a hollow cylindrical tube. The ends of mount 200 are captured by locating rings 219 which are formed by grooves 218 in arms 202 and 204. The indexing or locating rings 219 are present on both sides of the mount ends of arms 202 and 204. Only one of the two locating rings in arm 202 is shown in this perspective view. The locating rings ensure the mount 200 stays in position relative to the arms.

In this embodiment, mount 200 is perpendicular to support structure 208. It is often desirable to have a mount perpendicular to the support structure, for instance, a horizontal mount on a vertical tube. Many accessories for bicycles, motorcycles, etc. are made for mounting to the handlebars, which are generally horizontal. Since space is often limited on handlebars, a mount which provides additional horizontal space is desirable. A mount which can convert an unused vertical support structure into a horizontal mount is beneficial. There are of course other instances where it is desired to convert a horizontal support structure to a vertical one. With this embodiment, it is a simple matter to do so.

### Operation

### First Embodiment

### FIG. 2

To install the accessory mount of FIG. 2, attachment clamps 206 are first placed on the support structure. The attachment clamp ends of arms 202 and 204 are then connected to the clamps using fasteners 210 and spacers 212. The mount is adjusted by moving or sliding the clamps 206 closer together or further apart on the support structure as the arms pivot about the mount. This changes the triangle formed by the longitudinal axes of mount 200 and the clamp fasteners 210. Once the accessory mount has been adjusted to position the mount where desired, the fasteners are tightened, fixing the triangle and making the accessory mount rigid.

In operation, forces applied to mount 200 by the accessory are transferred to arms 202 and 204 and thence to clamps 206. Since the vertical structure is that of a triangle, vertical loads on mount 200 will put the arms 202 and 204 primarily in tension and compression, not bending. This allows the arms to be made lighter and more simply than other mounts using a single arm and a single attachment clamp. Further, the forces applied to the support structure will be lower, as the moment forces are greatly decreased as compared to a mount with a single clamp.

The pivot points of arms 202 and 204 are shown near their ends, but this is not a requirement. Arms 202 and 204 could extend past the pivot points in various ways if needed without affecting the essential linkage nature of the accessory mount.

The ability to readily substitute a different method of attachment is a desirable feature of this accessory mount. Separating the attaching/clamping function from the arms enables a wide variety of readily available clamps to be employed. It also allows different types of clamps to be used for each arm, according to the requirements of the support structure. Other types of clamps and other methods of attachment to the support structure may readily be substituted without changing the operation of the accessory mount.

Alternatively, mount 200 could be made of a solid cylinder with a lengthwise hole for passage of mount fastener 220. In this configuration, fastener 220 would serve to ensure mount 200 stays in position relative to the arms, and grooves 218 would not be needed. In typical use, mount fastener 220 would be a threaded bolt with a nut or other way of threadably tensioning the far side of arm 204, but other configurations would work as well, for instance, if both ends of the solid mount had threaded holes to receive bolts.

If needed, the mounting surface of mount 200 can be modified to be a better place to mount various accessories. For instance, grooves or ridges may be added to keep elastic bands in place for those accessories that are held on by elastic straps or bands.

Spacers 212 are shown sized to match the length of mount 200 with the width of the ears of attachment clamps 206. The spacers may be single piece, multiple piece, or of different lengths. All that is required is that they allow the attachment ends of the arms to be spaced apart as needed. By making them different lengths, mount 200 may be moved from side to side relative to the support structure 208.

The connecting pivot axis of the mount ends of arms 202 and 204 of FIG. 2 is shown as concentric with both the mount 200 and the mount fastener 220. This provides a number of conveniences, but is not required.

Support structure 208 is shown as a simple cylinder with constant radius. It is not a requirement that it is cylindrical or that the radius is constant. All that is required is that suitable clamps 206 be provided to attach where needed. Support structure 208 could be L shaped, for example, with one clamp 206 on the upright part of the L and the other clamp 206 on the horizontal part of the L.

Support structure 208 is also shown as smooth and free of other attached objects. Because the clamps 206 may be spaced apart from each other, it is possible to span another object on support structure 208 by putting one clamp 206 on one side of it, and the second clamp 206 on the other side of it. Since each the clamps 206 do not have to be made to carry the full load of the accessory mount, they can be made smaller and narrower, to fit in places other accessory mount attachment clamps might not.

Arms 202 and 204 as shown are made of a flat material but can be made in many shapes and cross sections. Contact between the ends of mount 200 and the faces of arms 202 and 204 serves to stiffen and stabilize the accessory mount against side to side and twisting forces. The width and height of the contact reduces stresses on the arms. The length of mount 200 spaces the arms apart, giving the accessory mount a wider stance and making it stiffer than it would be if the arms 202 and 204 were in the same plane.

Clamps 206 control the spacing of the triangle formed by this accessory mount. Since many types of clamps are strongly resistant to slipping, it is easy to make the triangle rigid. Friction developed by the connection of mount 200 to arms 202 and 204 serves to increase the rigidity of the triangle as well. In the accessory mount of Kwiatkowski, the rigidity of its trapezoidal structure is determined only by the friction of the pivots.

Mount 200 also serves to stiffen arms 202 and 204 against twisting. The circular connecting surfaces at the ends of mount 200 are broad and spaced at a distance from fastener 220, providing bracing for the arms. If additional resistance to twisting is required, an additional arm 202 or 204 may be attached in parallel on the opposite side of mount 200. In the configuration shown, the additional arm would then pivot on fastener 220. The other end of the additional arm could be attached to ear 214 of the matching clamp 206 with an additional spacer 212 on an extended clamp fastener 210. A threaded nut could then be used to secure the attachment end of the additional arm to the clamp. With the restricted forces on arms 202 and 204, they can be made simply and economically. Additional arms can be provided at low cost.

### Description and Operation

### Alternative Embodiment

### FIGS. 3A and 3B

FIG. 3A shows another embodiment of the accessory mount demonstrating additional adjustment. In this embodiment, attachment clamp 206A and clamp fastener 210 serve to attach arm 204A to one side of support structure 208. Arm 202A is similarly attached to clamp 206B, but on the opposite side of support structure 208. In other respects, the accessory mount of FIG. 3A is similar to the accessory mount of FIG. 2. Arms 202A and 204A are connected to Mount 200 and held by mount fastener 220. Grooves 218 formed in the mount ends of the arms create locating rings 219 to capture circular ends of hollow cylindrical mount 200.

This alternative attachment clamp arrangement provides additional triangulation possibilities, which provides an additional range of adjustments as compared to the configuration of FIG. 2. No new parts are required, they are just arranged differently. In FIG. 2, both arms attach on the same side of the support structure. In FIG. 3, the arms are attached on opposite sides of the support structure. It is also possible to attach both arms on one side of the support structure, and put the mount on the opposite side of the support structure. This creates a third set of adjustment possibilities.

FIG. 3A also demonstrates how changing the positions of the attachment clamps changes the triangulation and the subsequent repositioning of the mount. As the attachment clamp 206B is moved to the position indicted by clamp 206C, arm 204A moves to position 204B, arm 202A moves to 202B, and mount 200 moves to 200A.

The view along Section line 3-3 is shown in FIG. 6A.

FIG. 3B shows another alternative way of providing adjustment. Telescoping arm assembly 300 consists of slotted arm 304 with attachment/pivot hole 310 and slot 306. Mount arm 301 is slidably attached to slotted arm 304 via control fasteners 308. Control fasteners 308 pass through slot 306 and are threadably attached to mount arm 301. Hole 302, groove 218, and locating ring 219 serve to connect arm 301 to a mount as in FIGS. 2 and 3A.

In operation, the distance between the pivot point at the center of locating ring 219 and the center of attachment/pivot hole 310 may be varied by sliding slotted arm 304 relative to mount arm 301. When the desired distance has been achieved, control fasteners 308 are tightened, preventing further sliding and making the arm rigid. Such a telescoping arm, in combination with the mounts of FIGS. 2 and 3A, creates significant additional positional adjustment possibilities. The telescoping mechanism shown in FIG. 3B is representative, and many other telescoping methods could also be employed. For instance, an array of holes could be used, or one part of the arm could slide inside the other.

A telescoping arm functionally equivalent to the arm of FIG. 3B may of course be substituted for any of the arms shown in FIGS. 2, 3A, 4, 5, 6A, 6B, 6C, and 7 to expand the adjustment range of the mount.

### Description and Operation

### Alternative Embodiment

### FIG. 4

FIG. 4 is a side view of an alternative embodiment where arms 400A and 400B are curved or shaped to avoid obstacles. The accessory mount of FIG. 4 is similar in construction and operation to the mounts of FIGS. 2 and 3A and includes a mount 200 disposed between arms 400A and 400B in an analogous fashion to the way mount 200 is disposed between arms 202 and 204 in FIG. 2.

In this embodiment, curved arm 400A is attached to support structure 404 via attachment clamp 206 and clamp fastener 210. Curved arm 400B is similarly attached to the support structure via a second clamp 206. Curved arms 400A and 400B are identical except for their orientation. A light or other accessory 406 is attached via accessory mounting clamp 408 to the hollow cylindrical mount connecting arms 400A and 400B. The hollow cylindrical mount is held in place by locating rings 219 formed by grooves 218 in both sides of flat faces of arms 400A and 400B. Curved arms 400A and 400B have concave sides 412 and convex sides 420.

Support structure 404 is part of a recumbent bicycle with frame member 416 connected to bottom bracket shell 418 and support structure 404. FIG. 4 is representative of interference issues encountered when mounting accessories to various vehicles and structures.

Accessory 406 has an interfering feature 410 which protrudes towards arm 400B. Arm 400B has concave side 412 and convex side 420. To create clearance 414, arm 400B is configured with concave side 412 facing upwards towards accessory 406. To create clearance 422 between bottom bracket shell 418 and arm 400A, arm 400A is configured with concave side 412 facing downwards. Because locating rings 219 are formed in both sides of arms 400A and 400B, either arm may be flipped and used in either configuration as needed. This adds to the versatility of the accessory mount and enables it to be used in more situations. Curved arms provide similar benefits in the embodiments of FIGS. 2, 3A, 3B, 5, 6A, 6B, 6C, and 7. Of course, different curved shapes, including multiple curves, may be employed as needed.

FIG. 4 also further demonstrates the triangulation inherent in the mount. Even though accessory 406 is some distance from the attachment clamps 206 due to the length of arms 400A and 400B, the distance between clamp fasteners 210 is sufficient to create a sturdy triangle.

### Description and Operation

### Alternative Embodiment

### FIG. 5

The embodiment of FIG. 5 demonstrates an alternative attachment and shows fixed length arms of different lengths. In this embodiment, attachment clamp 206 and clamp fastener 210 serve to attach upper arm 502 to a bicycle fork blade 504. A dropout 506 with axle slot 508 and mounting tab 510 is affixed to the lower end of the fork blade. Such mounting tabs are commonly supplied for the attachment of fenders. Lower arm 500 is attached to mounting tab 510 with a fastener 512. Arms 500 and 502 are similar to those described previously, and show a locating ring 219 formed by a groove 218 on the flat face of arm 500. The mount 200 connects the arms. The arms are held to the mount by fastener 220 as described in FIG. 2. This embodiment demonstrates an alternative way of attaching the mount to a support structure, and further shows how fixed length arms of different sizes may be employed. Since mounting tab 510 is fixed to fork blade 504 and cannot move, the strength requirements of clamp 206 are reduced.

### Description and Operation

### Alternative Embodiments

### FIGS. 6A, 6B, and 6C

FIG. 6A is a cross sectional view of the embodiment of FIG. 3A taken along section line 3-3. It demonstrates one way of holding mount 200 and arms 202 and 204 together. Clamps 206 are shown stacked on support structure 208. Fasteners 210 hold ends of arms 202 and 204 to clamp ears 215 via spacers 212. Fasteners 210 further tension clamps 206 via ears 214. Gap 216 between ears 215 and 214 gets smaller as clamps 206 are tensioned.

Arms 202 and 204 extend to hollow cylindrical mount 200. Grooves 218 formed in the faces of arms 202 and 204 create locating rings 219 which interface with the interior of mount 200. Fasteners 220 pass through arms 202 and 204 and are connected via a coupler nut 600.

FIG. 6A also shows how a clearance 602 may be provided for passage of an arm past clamp 206 or other protrusion on support structure 208. By arranging the length of mount 200 and the lengths of spacers 212, the arms can be made to clear various obstacles.

Alternatively, the coupler nut and one of the mount fasteners 220 could be eliminated, and the remaining fastener 220 extended to pass through arm 202, mount 200, and arm 204. A threaded nut could complete the tensioning function against arm 204. The coupler nut method shown is beneficial, as it does not require an additional tool to operate the mount. The same tool can operate both fasteners 220 when the coupler nut 600 is used. Other alternatives to coupler nut 600 include putting a pair of star nuts inside mount 200 or making mount 200 from a solid material with threaded holes in each end.

FIG. 6B shows an alternative embodiment of the mount of FIG. 6A. An extension mount 604 is attached to arm 202 via an end cap 606 and mount fastener 220. The extension mount is similar in construction to mount 200 and is captured by locating ring 219 on the outer face of arm 202. Cap 606 is disk shaped and has a groove around it's periphery to create a locating ring 219 similar to the locating rings on the arms. In other respects, the mount of FIG. 6B functions similarly to the mount of FIG. 6A. Elements numbered 204, 206, 208, 210, 212, 214, 215, 216, 218, 600, and 602 are the same as those of FIG. 6A.

Extension mount 604 could also be constructed from a solid material with a hole through it for fastener 220. In this case, end cap 606 would not be required. If desired, a second extension mount could be attached to the other side, on the outside of arm 204. Extension mount 604 is shown as being shorter than mount 200, but it can be of any length. If it is the same length as mount 200, it can even be the same part.

FIG. 6C shows a cross section of another alternative embodiment. In this embodiment, a mounting tab or arm 610 from an accessory extends inside mount arms 202 and 204. Mount fastener 612 passes through arm 202, upper spacer 608, mounting tab 610, lower spacer 608, and through arm 204. Threaded nut 614 allows fastener 612 to squeeze everything together and hold the accessory via tab 610. In this configuration, fastener 612 serves as the locating part of the mount, and spacers 608 serve as the anti rotation part of the mount. The ends of spacers 608 have surfaces that connect to and space apart arms 202 and 204. The remainder of this embodiment is similar to the embodiments of FIGS. 6A and 6B. Elements numbered 206, 208, 210, 212, 214, 215, 216, 218, 219, and 602 are the same as those of FIG. 6A.

Of course, the features provided on arms 202 and 204 for locating a hollow cylindrical style mount are not required for this embodiment, but they do not cause problems if present. This allows one type of arm to suffice for use with more than one type of mount. Also, mounting tab 610 may be placed on the outside of arms 202 or 204, and spacers 608 can be of different lengths without changing the essential nature of the embodiment.

### Description

### Alternative Embodiment

### FIG. 7

The embodiment of FIG. 7 shows an accessory mount with the mount element parallel to the support structure. By adding cross drilled blocks 700 between the attachment lamps 206 and the arms 202 and 204, the arms are turned perpendicular to support structure 208. Arm attachment fasteners 702 provide pivoting attachment of the arms to blocks 700. Mount 704 connects the other ends of the arms in a similar manner to mount 200 of FIG. 2. Since mount 704 is perpendicular to the arms, it is parallel to the support structure. Mount 704 is shown as an elongated version of mount 200, but it can be any length desired. Mount fasteners 220 hold arms 202 and 204 to mount 704 in a manner similar to that in FIG. 6A. The embodiment of FIG. 7 is similar in most respects to that of the embodiment of FIG. 2, but the addition of blocks 700, attachment fasteners 702, and the rearrangement of the clamps 206 produces a new benefit, namely that the mount 704 is no longer perpendicular to the support structure 208. The pivot axes of the attachment fasteners 702 and the mount 704 are now parallel to the main axis of support structure 208.

Clamps 206 are shown as band clamps but can be any suitable clamp. Clamp fastener 210 holds block 700 to clamp 206 while also tensioning the clamp. Block 700 has a clearance hole for fastener 210 and a perpendicular threaded hole to receive an arm attachment fastener 702. Attachment ends of arms 202 and 204 are held to blocks 700 by arm attachment fasteners 702.

As described in the embodiment of FIG. 4, making the arms curved so they have concave sides 412 helps the arms avoid other objects. In this case, concave sides 412 also help the arms clear the support structure 208 and extend the adjustment range.

### Operation

### Alternative Embodiment

### FIG. 7

To install the accessory mount of FIG. 7, clamps 206 and blocks 700 are first installed on support structure 208. Arms 202, 204 and mount 704 are then attached. The mount 704 is positionally adjusted by rotating the clamps 206 around support structure 208 while the arms pivot around mount 704. When the desired position is reached, all fasteners are tightened and the mount becomes rigid. Arms 202 and 204 do not have to be the same length.

It is beneficial to position clamps 206 around support structure 208 in such a way that the longitudinal axes of arm attachment fasteners 702 are spaced apart from each other. This provides triangulation to the accessory mount and improves its rigidity. As in the previously described embodiments, the position of the mount and the triangulation may be adjusted.

While block 700 is shown as a D shaped block, the function provided by this element can take many shapes. Another common shape for such an element would be an L bracket.

By rotating blocks 700 around clamp fasteners 210, it is possible to position mount 704 at an angle between parallel and perpendicular to support structure 208.

### CONCLUSIONS, RAMIFICATIONS, AND SCOPE

Accordingly the reader will see that, according to the embodiments of the invention, an accessory mount mechanism is provided that has an inherently rigid, triangular structure;
is adapted for use with a variety of attachment techniques;
is positionally adjustable in several different ways, making it unusually versatile;
is able to hold accessories designed to mount to a cylinder;
is able to hold accessories designed to mount via a tab;
may be shaped to avoid obstacles;
a may be configured to provide a mount perpendicular or parallel to the support structure;
is easily reinforced if needed by adding additional similar parts;
is reconfigurable by simply changing the orientations of its parts;
is extendable;
and is easily and simply made.

The versatility of the accessory mount described is provided by a synergistic combination of its elements. It's use of a variety of attachment types and locations; it's use of multiple, pivotable arms; and it's ability to work with a variety of mount types combine to enable it to be used in a wide range of accessory mounting situations.

While the above description contains many specificities, these should not be construed as limitations on the scope of any embodiment, but as exemplifications of the presently preferred embodiments thereof. Many other ramifications and variations are possible within the teachings of the various embodiments. For example, fasteners, materials, clamps, shapes, and orientations of the parts may all be changed or substituted without changing the essential nature of the invention.

Thus the scope of the invention should be determined by the appended claims and their legal equivalents, and not by the examples given.

1. An adjustable mechanism for the mounting of an object to a support structure, comprising:
(a) a mount where said object may be attached;
(b) first and second link arms, each having a first pivot point and a second pivot point;
(c) a movably adjustable first attachment means on said structure;
(d) a second attachment means on said structure;
(e) pivotable joining means connecting said mount and said first pivot points of said arms;
(f) pivotable joining means connecting said second pivot point of said first arm to said first attachment means;
(g) pivotable joining means connecting said second pivot point of said second arm to said second attachment means;
whereby an adjustable linked mechanism is created extending from the support structure and the position of said mount relative to said support structure may be adjusted by moving said first attachment means.

2. An adjustable mechanism for the mounting of an object to a support structure as in claim 1, wherein said second attachment means is also movably adjustable.

3. An adjustable mechanism for the mounting of an object to a support structure as in claim 1, wherein one of said attachment means includes a clamp.

4. An adjustable mechanism for the mounting of an object to a support structure as in claim 3, wherein said clamp is a band type clamp.

5. An adjustable mechanism for the mounting of an object to a support structure as in claim 1, wherein one of said arms includes a means of adjusting the distance between said pivot points of said arm.

6. An adjustable mechanism for the mounting of an object to a support structure as in claim 1, wherein one of said arms is shaped to avoid obstacles.

7. An adjustable mechanism for the mounting of an object to a support structure as in claim 1, wherein said mount is substantially cylindrical.

8. An adjustable mechanism for the mounting of an object to a support structure as in claim 7, wherein said cylindrical mount is hollow, and the circular ends of said cylindrical mount are indexed to said arms by rings formed in said arms.

9. An adjustable mechanism for the mounting of an object to a support structure as in claim 1, wherein said mount is adapted to connect to a tab or arm on said object.

10. An adjustable mechanism for the mounting of an object to a support structure as in claim 1, wherein said mount includes a means for stabilizing said arms.

11. An adjustable mechanism for the mounting of an object to a support structure as in claim 1, wherein the axes of said pivotable joining means are substantially perpendicular to said support structure.

12. An adjustable mechanism for the mounting of an object to a support structure as in claim 1, wherein the axes of said pivotable joining means are substantially parallel to said support structure.

13. An adjustable mechanism for the mounting of an object to a support structure, comprising:
(a) a mount with a first connecting surface, a second connecting surface at a predetermined distance from said first connecting surface, and a place where said object may be attached;
(b) first and second link arms, each having a first pivot point and a second pivot point;
(c) a movably adjustable first attachment means on said structure;
(d) a second attachment means on said structure;
(e) pivotable joining means connecting said first pivot point of said first arm to said first connecting surface of said mount;
(f) pivotable joining means connecting said first pivot point of said second arm to said second connecting surface of said mount;
(g) pivotable joining means connecting said second pivot point of said first arm to said first attachment means;
(h) pivotable joining means connecting said second pivot point of said second arm to said second attachment means;
whereby an adjustable linked mechanism is created extending from the support structure and the position of said mount relative to said support structure may be adjusted by moving said first attachment means.

14. An adjustable mechanism for the mounting of an object to a support structure as in claim 13, wherein said second attachment means is also movably adjustable.

15. An adjustable mechanism for the mounting of an object to a support structure as in claim 13, wherein one of said attachment means includes a clamp.

16. An adjustable mechanism for the mounting of an object to a support structure as in claim 13, wherein one of said arms includes a means of adjusting the distance between said pivot points of said arm.

17. An adjustable mechanism for the mounting of an object to a support structure as in claim 13, wherein one of said arms is shaped to avoid obstacles.

18. An adjustable mechanism for the mounting of an object to a support structure as in claim 13, wherein said mount is substantially cylindrical.

19. A method of adjustably mounting an object to a support structure, comprising:
(a) providing a mount where said object may be attached;
(b) providing first and second link arms, each having a first pivot point and a second pivot point;
(c) providing a movably adjustable first attachment means on said structure;
(d) providing a second attachment means on said structure;
(e) pivotably joining said first pivot points of said arms and said mount;
(f) pivotably joining said second pivot point of said first arm to said first attachment means;
(g) pivotably joining said second pivot point of said second arm to said second attachment means; and
(h) adjusting the location of the mount by moving said first attachment means, thus pivoting said arms about said pivotable joinings and changing location of said mount relative to said support structure.

20. The method of claim 19 further including:
(a) providing a means of changing the distance between the pivot points of said link arms; and
(b) adjusting the location of the mount by changing the distance between the pivot points of one of said link arms.
